(19) United States
(12) Patent Application Publication
(10) Pub. No.: US 2004/0012724 A1
(43) Pub. Date: Jan. 22, 2004

(54) Video process device capable of realizing triple-window and method of realizing the same

(75) Inventor: Geun-Sik Jang, Suwon-City (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/447,963

(22) Filed: May 30, 2003

(30) Foreign Application Priority Data
Jun. 14, 2002 (KR) 2002-33175

(51) Int. Cl. H04N 5/66; H04N 9/12

(52) U.S. Cl. 348/739

(57) ABSTRACT

A video process device includes: a display device rotatable with respect to a center point of a screen; a first screen dividing portion for processing first and second video signals into a double window video signal; a second screen dividing portion for processing the double window video signal and an inputted third video signal into a triple window video signal; and a controller for controlling the second screen dividing portion in order to transform a vertical and horizontal synchronization signal of the first, second and third video signals to correspond to the screen of the display device rotated by 90° when the display device is rotated by 90°. Accordingly, by realizing the triple window in consideration of the aspect ratio of 16.9 of the display device, problems such as image quality deterioration and signal distortion can be solved. Also, the opportunity to watch various broadcasting can satisfy a user's needs.

### BACKGROUND OF THE INVENTION

1. Field of the Invention

The present invention relates to a video process device, and more particularly, to a video process device having an aspect ratio of 16:9. The present application is based on Korean Patent Application No. 2002-33175, filed Jun. 14, 2002, which is incorporated herein by reference.

2. Description of the Related Art

Widevision is a general example of a video process device having a display device with an aspect ratio of 16:9. A widevision display device uses a CRT, an LCD (Liquid Crystal Display), or a PDP (Plasma Display Panel). However, it is difficult to make a CRT screen larger than 36 inches due to its physical structure. Due to the projection distance between an electron beam gun and a phosphor screen, it is impossible to design the CRT to make a completely flat screen. Also, enlarging the screen size causes problems of increased weight and volume and power consumption. For the reasons described above, the LCD and the PDP are generally used for a wide screen.

Also, demand for teletext broadcasting has increased as interactive digital medium has been recently developed. Accordingly, in order to satisfy the consumers' increasing demand, a technology is developed to increase the use of the teletext broadcasting through realization of a rotatable display device having an LCD or a PDP. Also, in order to utilize a multi-broadcast format more effectively, a technology that allows two different images to be displayed on one screen simultaneously by using a screen process function such as a PIP (Picture in Picture) and a double window has been developed and popularized.

The PIP is a function that displays a sub-screen in a predetermined area of one main screen. The double window is a function that displays two video signals having the same aspect ratio in one screen.

FIG. 1 is a schematic block diagram showing a television having a conventional double window function.

The television has an external signal input portion 10, an input portion 20, a selection portion 30, a signal processing portion 40, a microcomputer 50, a scaler 60, a memory 61 and a display device 70.

The external signal input portion 10 receives an external signal from Turners I and II and external input devices I and II.

The input portion 20 receives a selection command, i.e., a television manipulation command for selecting a predetermined external input signal among a plurality of external input signals.

The selection portion 30 selects the predetermined external input signal in accordance with the selection command input through the input portion 20 and outputs the selected external input signal. If the external input signals that are output from the selection portion 30 are a first video signal S1 and a second video signal S2, the signal processing portion 40 separates a brightness signal and a color signal from the first and second video signals, respectively. The signal processing portion 40 also separates vertical/horizontal synchronization signals from the first and second video signals and outputs the same.

The scaler 60 scales the processed first and second video signals S1 and S2 to display the same in a predetermined screen size. For example, when the double screen function is selected, the scaler 60 scales the first and second video signals to display the same in two-divided screens of the display device 70 (e.g., an LCD), respectively, as shown in FIGS. 2A-2C.

That is, the double window function is performed in a manner that the scaler 60 stores the first and second video signal S1 and S2 in a memory 61 by a field unit or a frame unit, and then scales the first and second video signal S1 and S2 into the sizes that correspond to the two-divided screens of the display device 70.

When the above-described double window function is processed in the display device 70 having an aspect ratio of 16:9, the screen for displaying two video signals is classified into the type A and type B.

The screen type A in FIG. 2B shows the case where a video signal processed according to an aspect ratio of 16:9 is processed into a signal such that an originally-circular image is enlarged in a vertical direction and thus displayed in the shape of an oval. The screen type B in FIG. 2C shows the case where the originally-circular image is displayed with its original shape with blank areas formed at an upper portion and a lower portion of the display device 70.

As described above, when the double window function is performed in the convention display device having an aspect ratio of 16:9, there occurs image distortion in the screen type A, while there occurs image quality deterioration in the screen type B.

### SUMMARY OF THE INVENTION

An object of the present invention is to provide a video process device having a display device having an aspect ratio of 16:9 capable of improving viewing efficiency by realizing a more effective aspect ratio.

The above object is accomplished by a video process device comprising: a display device rotatable with respect to a center point of a screen; a first screen dividing portion for processing a first video signal and a second video signal into a double window video signal; a second screen dividing portion for processing the double window video signal and an inputted third video signal into a triple window video signal; and a controller for controlling the second screen dividing portion in order to transform a vertical and horizontal synchronization signal of the triple window video signal to correspond to the screen of the display device when the display device is rotated.

When the display device is rotated by 90°, the controller controls the second screen dividing portion in order to transform the vertical and horizontal synchronization signal of the first, second and third video signals to correspond to the screen of the display device rotated by 90°.

Preferably the first screen dividing portion comprises: a first signal processing portion for processing first and second video signals into a predetermined video signal; a first memory for storing the processed first and second video signals by a field unit and/or a frame unit; and a first scaler for scaling first and second video signals stored in the first memory to display first and second video signals in one screen of the display device.

The second screen dividing portion comprises: a second signal processing portion for processing the double window video signal output from the first screen dividing portion and the third video signal into a predetermined video signal; a second memory for storing the processed double window video signal and third video signal by a field unit and/or a frame unit; and a second scaler for scaling the double window video signal and the third video signal stored in the second memory to display the double window video signal and the third video signal in one screen of the display device.

Screen sizes of the double window video signal and the third video signal, both being down-scaled by the second scaler, are in a ratio of 2:1, and screen sizes of first, second and third video signals are in ratios of 1:1:1. When the display device is rotated by 90°, the vertical and horizontal synchronization signal of first, second and third video signals are transformed such that a screen of each video signal has an aspect ratio of 16:9.

Meanwhile, a method is provided for dividing a screen of a video process device having a display device rotatable with respect to a center point of the screen, the method comprising the steps of: processing inputted first and second video signals into a double window video signal; processing the double window video signal and an inputted third video signal into a triple window video signal; and transforming a vertical and horizontal synchronization signal of the triple window video signal to correspond to the screen of the display device when the display device is rotated, and outputting the transformed vertical and horizontal synchronization signal to the screen of the display device.

When the display device is rotated by 90°, the transforming and outputting step transforms the vertical and horizontal synchronization signal of first, second and third video signals to correspond to a screen of the display device rotated by 90° and outputs the transformed vertical and horizontal synchronization signals to the screen of the display device.

According to the present invention, by realizing the triple window in consideration of the aspect ratio of 16.9 of the display device, the problems such as image quality deterioration and signal distortion can be solved. Also, the opportunity to watch the various broadcasting can satisfy a user's needs.

### BRIEF DESCRIPTION OF THE DRAWINGS

The above object and a feature of the present invention become more apparent by describing a preferred embodiment of the present invention in greater detail with reference to the accompanying drawings, in which:

FIG. 1 is a schematic block diagram showing a conventional television having a double window function;

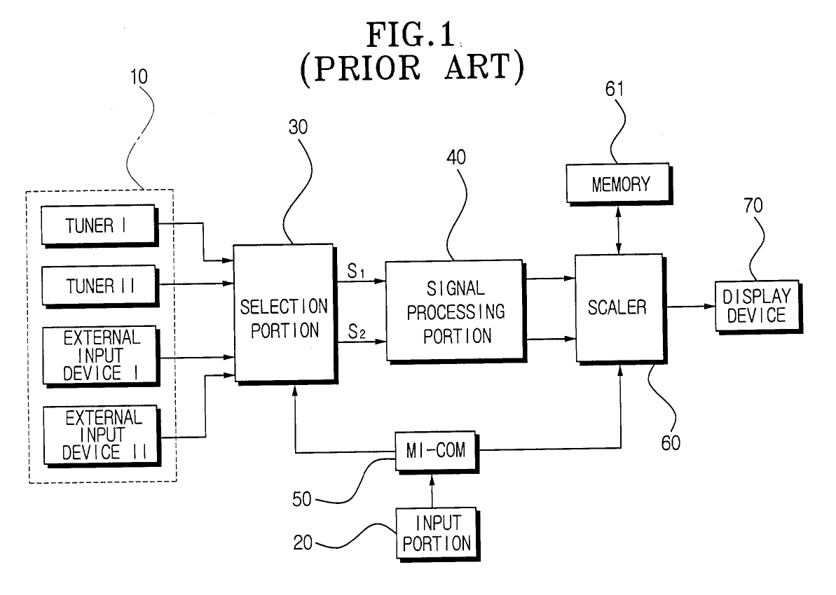

FIGS. 2A to 2C show different views of different processing states when the double window function is processed in the television of FIG. 1;

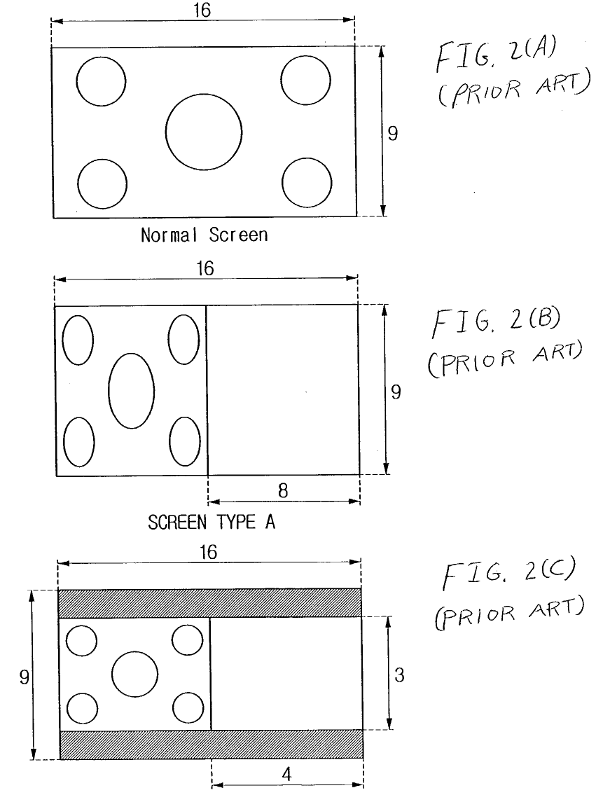

FIG. 3 is a schematic block diagram showing a television according to a preferred embodiment of the present invention;

FIGS. 4A and 4B are views showing a triple window being realized in a display device of the television of FIG. 3; and

FIG. 5 is a flow chart showing a method for dividing a screen of the television of FIG. 3.

### DETAILED DESCRIPTION OF THE PREFERRED EMBODIMENT

Hereinafter, a preferred embodiment of the present invention will be described in greater detail with reference to the accompanying drawings.

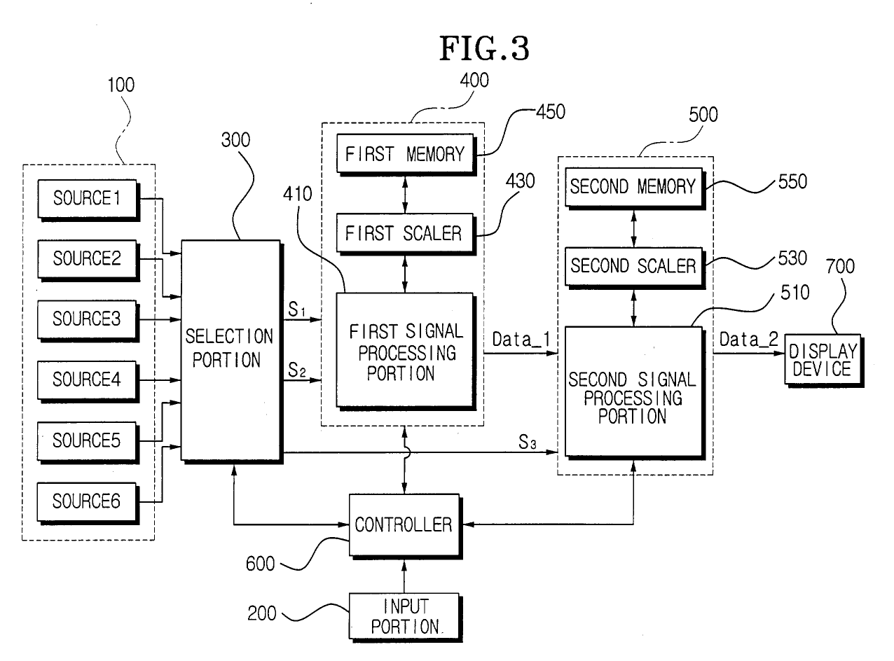

FIG. 3 is a block diagram showing a television according to the preferred embodiment of the present invention. The television has an aspect ratio of 16:9 and its display device 70 has a screen rotatable with respect to a central point. The television is capable of performing a triple window function such that three video signals scaled to have identical aspect ratios are displayed in a single screen.

The television has a plurality of external signal input portions 100, an input portion 200, a selection portion 300, a first screen dividing portion 400, a second screen dividing portion 500, a controller 600, and a display device 700.

The plurality of external signal input portions 100 receives general broadcasting signals that are input to a television and external input signals (Source 1, Source 2, . . . ) that are received from an image process device such as a VCR, a Super-VHS, a DVDP, a DTV, or a PC.

The input portion 200 is disposed on a television body and has a plurality of manipulation keys (not shown) for performing the operation of the television. A user's selection command is input through the manipulation keys of the input portion 200. Generally, a user inputs a selection command by using a remote controller having a plurality of keys (now shown) at a remote distance.

The selection portion 300 selects a predetermined external input signal among the broadcasting signals received from a tuner (not shown) and external input signals (Source 1, Source 2, . . . ) received from the VCR, the DVDP, the DTV, the PC, or the Super-VHS in accordance with a control of the controller 600. For example, when the external input signals Source 1, Source 2 and Source 3 among the plurality of external signal are selected from the input portion 200 to perform the triple window function, the selection portion 300 selects first, second and third external input signals Source 1, Source 2 and Source 3 in accordance with the control of the controller 600.

Hereinafter, it will be described how the external input signals Source 1, Source 2 and Source 3 selected for the triple window function are processed into the video signals S₁, S₂ and S₃.

The first screen dividing portion 400 processes the first and second video signals S₁ and S₂ among the selected first, second, and third video signals S₁, S₂ and S₃ into a double window video signal Data_1.

The first screen dividing portion 400 has a first signal processing portion 410, a first scaler 430, and a first memory 450.

The first signal processing portion 410 separates a color signal and a brightness signal from the first and second video signals S₁ and S₂ selected by the selection portion 300, and then creates a composite video signal by adjusting the brightness and demodulating the color signal. The first signal processing portion 410 also separates a vertical/horizontal synchronization signal from the first and second video signals S₁ and S₂.

The first scaler 430 stores the first and second video signals S₁ and S₂ by a field unit or a frame unit in the first memory 450, and then scales the stored first and second video signals S₁ and S₂ using, for example, a motion adaptive method. That is, the double window video signal Data_1 that is output from the first scaler 430 has one screen size, and the first and second video signals S₁ and S₂ are respectively displayed on the screen of the display device 700 with the identical aspect ratios.

The second screen dividing portion 500 processes the double window video signal (Data_1) that is output from the first screen diving portion 400 and consists of the first and second video signals S₁ and S₂, and the third video signal S₃ that is selected by the selection portion 300 into a triple window video signal Data_2.

The second screen dividing portion 500 has a second signal processing portion 510, a second scaler 530, and a second memory 550.

The second signal processing portion 510 outputs a composite video signal by adjusting a brightness and demodulating a color signal in regard to the double window video signal Data_1 and the third video signal S₃, and separates a vertical/horizontal synchronization signal from the double window video signal Data_1 and the third video signal S₃.

The second scaler 530 stores the double window video signal Data_1 and the third video signal S₃ by a field unit or a frame unit in the second memory 550, and then scales the stored double window video signal Data_1 and the third image signal S₃ in a motion adaptive method and outputs the triple window video signal Data_2.

At this point, the double window video signal (Data_1) is scaled to the size that corresponds to ⅔ of the width of the screen of the display device 700, and the third image signal S₃ is scaled to the size that corresponds to ⅓ of the width of the screen of the display device.

In the above descriptions, a screen of the double window video signal Data_1 output from the first screen dividing portion 400 has the same size as the screen of the display device 700.

Meanwhile, the screen size of the double window video signal Data_1 output from the first screen dividing portion 400 can correspond to ⅔ of the screen size of the display device 700.

The display device 700 is referred to as an LCD or a PDP and has an aspect ratio of 16:9. Also, the screen of the display device 700 is capable of rotating by 360° with respect to a center point. The display device 700 is manually rotated by a user, or automatically rotates corresponding to a rotation command.

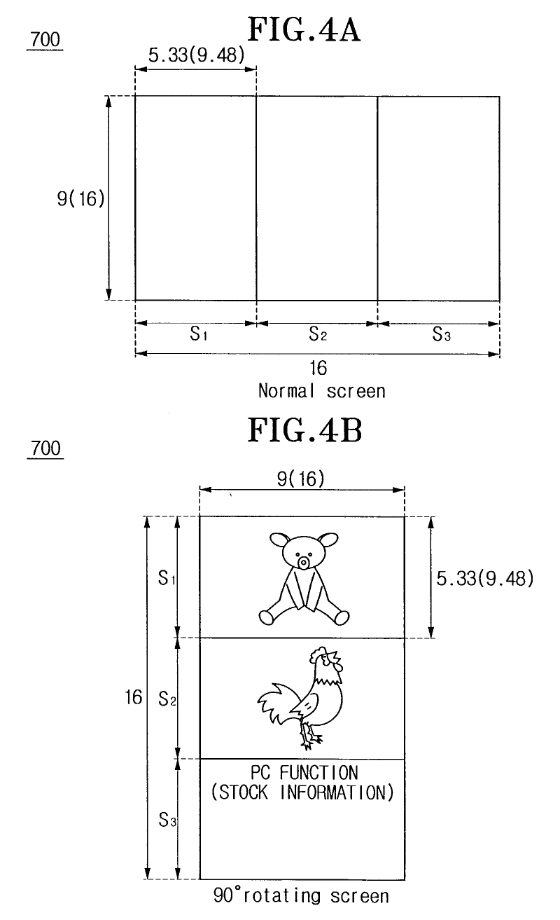

When the triple window function is selected in regard to the first, second and third video signals S₁, S₂, and S₃, the first and second screen dividing portions 400 and 500 divide the first, second, and third signals S₁, S₂, and S₃ to be respectively displayed in the display device 700 with equal screen sizes as shown in FIG. 4A. At this time, if the display device 700 is rotated by 90° manually by the user or automatically by the rotation command, the controller 600 controls the second screen dividing portion 500 to transform the vertical/horizontal synchronization signals of divided first, second and third video signals S₁, S₂, and S₃ to correspond to the screen of the display device 700 that is rotated by 90°.

Accordingly, as shown in FIG. 4B, each of first, second and third video signals S₁, S₂, and S₃ has an aspect ratio of 9:5.33 i.e., 16:9.48, which is close to the aspect ratio of 16:9. Since the deviation of 0.48 is almost negligible as a general over-scanning, each video signal has a complete aspect ratio of 16:9.

By realizing the triple window in the display device having the aspect ratio of 16:9 by rotating the display device by 90°, problems such as signal distortion and image quality deterioration can be solved, and a user is allowed to simultaneously watch video signals that are input from the various broadcasting apparatus.

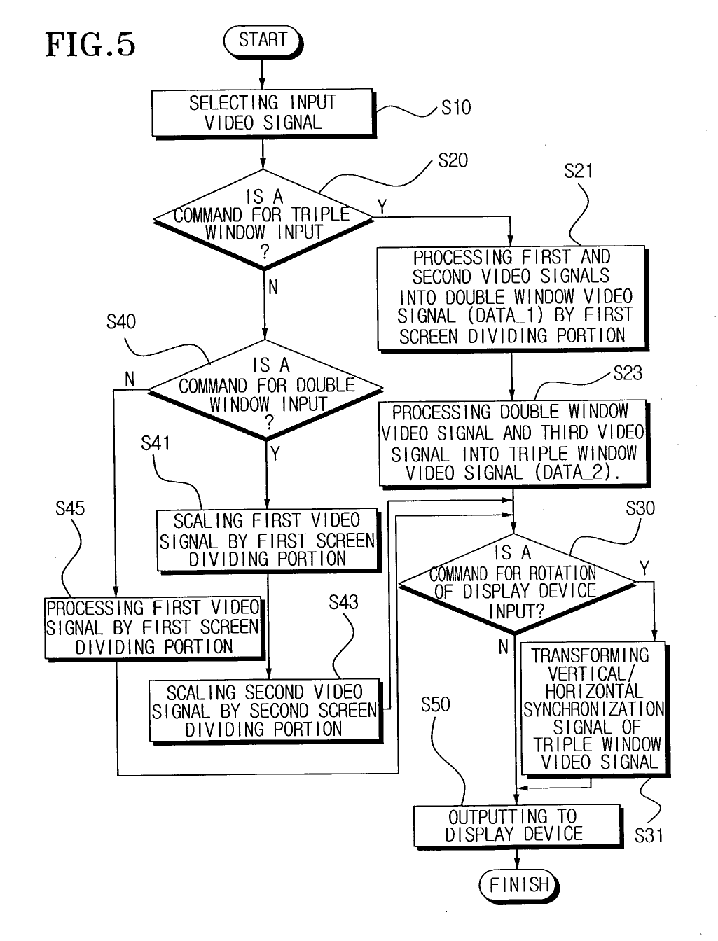

Referring to FIG. 5, a method for realizing a plurality of video signals on a screen having an aspect ratio of 16:9 will be described in greater detail.

A user selects a desired external input signal among the various external input signals (Source 1, Source 2, . . . ) (Step S10).

For example, when a selection command for a triple window function is selected in Step S10 (Step S20), the first screen dividing portion 400 processes the first and second video signals S₁, and S₂ that corresponds to the first and second external input signals Source 1 and Source 2 of the selected external input signals Source 1, Source 2, and Source 3 into a double window video signal Data_1 (Step S21).

After that, the second screen dividing portion 500 processes the third video signal S₃ of the third external input signal and the double window video signal Data_1 output from the first screen dividing portion 400 into the triple window video signal Data_2, and outputs the triple window image signal Data_2 (Step S23). That is, the second scaler 530 stores the double window video signal Data_1 and the third video signal S₃ by a field unit or a frame unit in the second memory 550, and then scales the double window video signal Data_1 and the third video signal S₃ in the motion adaptive method. At this point, as shown in FIG. 4A, the video signals Data_1 and S₃ are respectively scaled such that the double window video signal Data_1 corresponds to ⅔ of the total screen size and the third video signal S₃ corresponds to ⅓. Accordingly, the triple window video signals comprising first, second and third video signals S₁, S₂, and S₃ are displayed on the screen of the display device 700.

Consequently, it is determined whether a command for the rotation of the display device 700 is input (Step S30). When the command for the rotation of 90° is input to the controller 600 in the Step S30, the controller 600 transforms the vertical/horizontal synchronization signal of the triple window video signal Data_2 by controlling the second screen dividing portion 500 (Step S31) and outputs the transformed signals through the display device 700 (Step S50).

Meanwhile, when it is determined in Step S40 that a command for the double window function is input in Step S10, first and second signal processing portions 410 and 510 of first and second screen dividing portions 400 and 500 respectively process first and second video signals S₁, and S₂, and first and second scalers 430 and 530 scale the processed first and second video signals S₁, and S₂ by using first and second memories 450 and 550 (Steps S41 and S43).

Also, if it is determined in Step S40 that the double window function is not selected input in Step S10, the first signal processing portion 410 and the first scaler 430 of the first screen dividing portion 400 process the predetermined video signal selected by selection unit 300 (Step S45), and then outputs the signal to the display device 700 (Step S50).

As described above, the screen of the receiver 700 is effectively divided with the triple window function that is realized by rotating the receiver 700 having the aspect ratio of 16:9 by 90°. Accordingly, the various images can be displayed on one screen such that viewing efficiency is improved.

According to the present invention, by realizing the triple window in consideration of the aspect ratio of 16:9 of the display device 700, the problems such as image quality deterioration and signal distortion can be solved. Also, the opportunity to watch the various broadcasting can satisfy a user's needs.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A video process device comprising:
a display device rotatable with respect to a center point of a screen of the display device;
a first screen dividing portion for processing a first video signal and a second video signal into a double window video signal;
a second screen dividing portion for processing the double window video signal and an inputted third video signal into a triple window video signal; and
a controller for controlling the second screen dividing portion in order to transform vertical and horizontal synchronization signals of the triple window video signal to correspond to the screen of the display device when the display device is rotated.

2. The video process device of claim 1, wherein, when the display device is rotated by 90°, the controller controls the second screen dividing portion in order to transform the vertical and horizontal synchronization signals of the first, second and third video signals to correspond to the screen of the display device rotated by 90°.

3. The video process device of claim 1, wherein an aspect ratio of the display device is 16:9.

4. The video process device of claim 1, wherein the first screen dividing portion comprises:
a first signal processing portion for processing the first video signal and the second video signal into a predetermined video signal;
a first memory for storing the processed first and second video signals by a field unit and/or a frame unit; and
a first scaler for scaling the processed first and second video signals stored in the first memory to display the first and second video signals in one screen of the display device.

5. The video process device of claim 4, wherein the first and second video signals scaled by the first scaler have identical screen sizes.

6. The video process device of claim 1, wherein the second screen dividing portion comprises:
a second signal processing portion for processing the double window video signal output from the first screen dividing portion and the third video signal into a predetermined video signal;
a second memory for storing the processed double window video signal and the third video signal by a field unit and/or a frame unit; and
a second scaler for scaling the double window video signal and the third video signal stored in the second memory to display the double window video signal and the third video signal in one screen of the display device.

7. The video process device of claim 6, wherein screen sizes of the double window video signal and the third video signal, both being down-scaled by the second scaler, are in a ratio of 2:1, and screen sizes of first, second and third video signals are in ratios of 1:1:1.

8. The video process device of claim 7, wherein, when the display device is rotated by 90°, the vertical and horizontal synchronization signals of first, second and third video signals are transformed such that a screen of each video signal has an aspect ratio of 16:9.

9. A method for dividing a screen of a video process device having a display device rotatable with respect to a center point of the screen, the method comprising the steps of:
processing inputted first and second video signals into a double window video signal;
processing the double window video signal and an inputted third video signal into a triple window video signal; and
transforming vertical and horizontal synchronization signals of the triple window video signal to correspond to the screen of the display device when the display device is rotated, and outputting the transformed vertical and horizontal synchronization signals to the screen of the display device.

10. The method of claim 9, wherein, when the display device is rotated by 90°, the transforming and outputting step transforms the vertical and horizontal synchronization signals of first, second and third video signals to correspond to a screen of the display device rotated by 90° and outputs the transformed vertical and horizontal synchronization signals to the screen of the display device.

11. The method of claim 9, wherein an aspect ratio of the screen of the display device is 16:9.

12. The method of claim 9, wherein the double window video signal processing step comprises the steps of:
processing the first and second video signals into a predetermined video signal;
storing the processed first and second video signals by a field unit and/or a frame unit; and
scaling the stored first and second video signals to display the stored first and second video signals in one screen of the display device.

13. The method of claim 12, wherein the first and second video signals scaled in the double window video signal processing step have identical screen sizes.

14. The method of claim 9, wherein the triple window video signal processing step comprises the steps of:
processing the double window video signal processed in the double window video processing step and a third video signal into a predetermined video signal;
storing the processed double window video signal and the third video signal by a field unit and/or a frame unit; and
scaling the stored double window video signal and the third video signal to display the scaled double window video signal and third video signal in one screen of the display device.

15. The method of claim 14, wherein the double window video signal and the third video signal scaled in the triple window video signal processing step are displayed on a screen with the ratio of 2:1, and the first, the second and the third video signals are output in the ratio of 1:1:1 in the outputting step.

16. The method of claim 15, wherein, when the display device is rotated by 90°, the vertical and horizontal synchronization signal of the first, the second and the third video signals are transformed in the outputting step such that each signal has an aspect ratio of 16:9.
